(19) United States
(12) Patent Application Publication
(10) Pub. No.: US 2010/0318236 A1
(43) Pub. Date: Dec. 16, 2010

(54) MANAGEMENT OF THE PROVISIONING OF ENERGY FOR A WORKSTATION

(76) Inventors: John C. Kilborn, Winnetka, IL (US); Matthew Banach, Gurnee, IL (US); Jeffrey L. Clark, Holland, MI (US); Todd A. Thompson, Byron Center, MI (US); Gary C. Smith, Holland, MI (US)

Correspondence Address: BRINKS HOFER GILSON & LIONE, P.O. BOX 10395, CHICAGO, IL, 60610, US

(21) Appl. No.: 12/797,957

(22) Filed: Jun. 10, 2010

Related U.S. Application Data
(60) Provisional application No. 61/186,282, filed on Jun. 11, 2009.

(51) Int. Cl. G06F 1/26

(52) U.S. Cl. 700/295

(57) ABSTRACT

A system for management of workstation energy is provided. The system includes a workstation having an energy outlet operable to provide energy to the workstation, a workstation occupancy sensor disposed in the workstation, and a cluster energy manager coupled with the energy outlet and workstation occupancy sensor. The workstation may be connected in a workstation cluster. The workstation occupancy sensor may be operable to detect occupancy of the workstation. The cluster energy manager may have a distribution circuit configured to control energy provided to the energy outlet, the cluster energy manager operable to control the energy based on occupancy of the workstation and/or a network event. The cluster energy manager is operable to report occupancy or workstation energy consumption to a monitoring system.

### REFERENCE TO RELATED APPLICATIONS

This application claims the benefit of the filing date under 35 U.S.C. §119(e) of U.S. Provisional Application Ser. No. 61/186,282 filed Jun. 11, 2009, which is hereby incorporated by reference.

### BACKGROUND

Workstations may include components, such as computers, lighting or other devices, that consume energy. In an effort to control cost and conserve energy, administrators and employees desire to manage workstation energy provided to the workstations. As a result, administrators and employees may manually control workstation energy to the workstations. This may include turning on and off light switches, dimming or reducing the output of lighting systems, activating a low power or trickle charge mode, powering down computers, de-energizing electrical outlets or unplugging lighting systems. The manual control of the workstations consumes time and resources. Additionally, administrators and employees may forget to manually control workstation energy. Workstation energy may be wasted, which results in the expenditure of financial resources.

### BRIEF DESCRIPTION OF THE DRAWINGS

The present embodiments may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates one embodiment of a system for management of the provisioning of energy for a workstation;

FIG. 2 illustrates one embodiment of an energy manager for use with the system depicted in FIG. 1;

FIG. 3 illustrates one embodiment of an office environment;

FIG. 3A illustrates one embodiment of an energy manager in the office environment;

FIG. 3B illustrates one embodiment of managing workstation based on occupancy in an office environment;

FIG. 3C illustrates one embodiment of managing workstation based on an amount of workstation energy consumed in an office environment;

FIG. 3D illustrates one embodiment of managing workstation based on instructions received from a communication device;

FIG. 4 illustrates a block diagram of another embodiment of an energy manager;

FIG. 5A illustrates a schematic diagram of another embodiment of an energy manager;

FIG. 5B illustrates a block diagram of the embodiment shown in FIG. 5A;

FIG. 6 illustrates one embodiment of a communication system; and

FIG. 7 illustrates one embodiment of a method for management of workstation energy.

### DETAILED DESCRIPTION OF THE DRAWINGS AND PRESENTLY PREFERRED EMBODIMENTS

The present embodiments relate to the management of the provisioning of energy to a workstation. Energy to a workstation may include electrical power provided to one, some, or all of the workstations in a workstation cluster. A workstation cluster includes one or more, a number of, a plurality of, or a group of workstations having one or more components, such as walls, support structures, electrical distribution systems (or portions thereof), etc., in common. In one example, a workstation is a cubicle and a workstation cluster is a group of cubicles that are physically connected to each other in a work space.

Management of the provisioning of energy may include detecting occupancy of a workstation, measuring workstation energy consumption, reporting occupancy and/or energy consumption, distributing, controlling or otherwise regulating energy to one or more workstations, or any combination thereof. The present embodiments include systems, methods, and devices for management of the provisioning of energy for a workstation.

In a first aspect, a system for management of workstation energy is provided. The system includes a workstation having an energy outlet operable to provide energy to one or more energy consumption devices in a workstation, a workstation occupancy sensor disposed in the workstation, and a cluster energy manager coupled with the energy outlet and workstation occupancy sensor. Herein, the phrase “coupled with” is defined to mean directly connected to or indirectly connected through one or more intermediate components. Such intermediate components may include both hardware and software based components. The workstation may be connected in a workstation cluster. The workstation occupancy sensor may be operable to detect occupancy of the workstation. The cluster energy manager may have a distribution circuit configured to control energy provided to the energy outlet, the cluster energy manager operable to control the energy provisioned thereby based on occupancy of the workstation.

In a second aspect, a method for management of workstation energy is provided. The method includes receiving workstation energy via a workstation power line, the workstation power line operable to provide energy to one or more energy consumption devices in one or more workstations of a workstation cluster; receiving a network signal defining at least one network event; and managing the distribution of workstation energy to the one or more workstations based on the at least one network event, workstation energy being distributed to the one or more workstations via a workstation power line.

In a third aspect, a device for management of workstation energy is provided. The device includes a processor; and a memory coupled with the processor. The processor is operable to execute logic stored in a memory. The logic is executable by the processor to cause the processor to determine occupancy of one or more workstations; and distribute energy to one or more energy consumption devices in one or more workstations based on the occupancy of the one or more workstations.

Other systems, methods, devices, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below in conjunction with the embodiments.

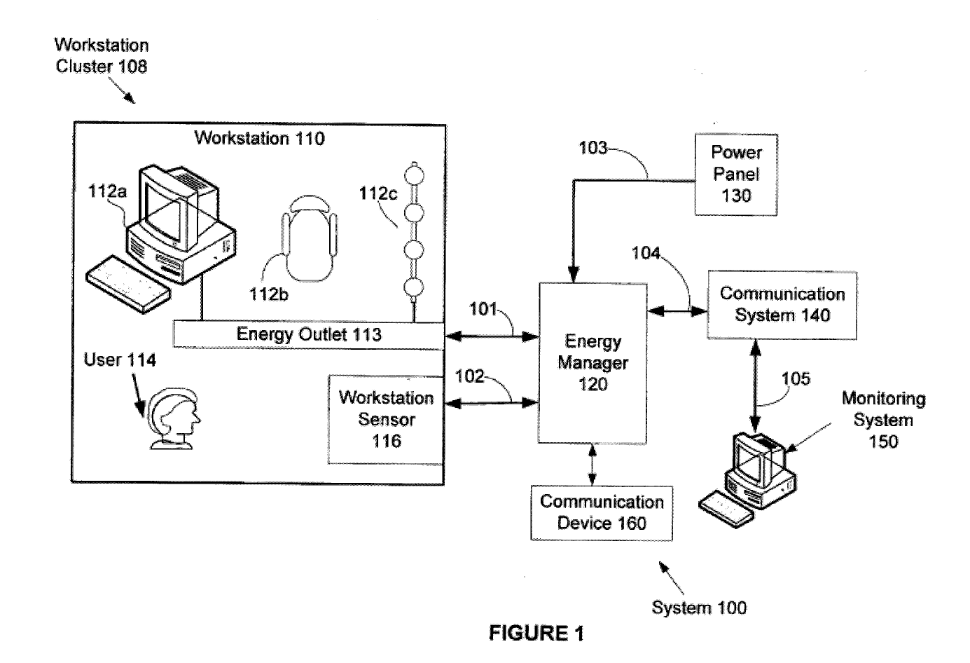

FIG. 1 shows a system 100 for management of the provisioning of energy to a workstation. The system 100 includes at least one workstation cluster (hereinafter workstation cluster) 108, at least one cluster energy manager (hereinafter cluster energy manager) 120, at least one power panel (hereinafter power panel) 130, at least one communication system (hereinafter communication system) 140, at least one monitoring system (hereinafter monitoring system) 150. The workstation cluster 108 may include at least one workstation (hereinafter workstation) 110. The workstation 110 may include a workstation sensor 116 and an energy outlet 113. The workstation sensor 116 may be coupled with, disposed in, in front of, above, below, around, or near the workstation 110. The workstation sensor 116 may be coupled with the cluster energy manager 120 via occupancy line 102. The energy outlet 113 may be coupled with the cluster energy manager 120 via the workstation power line 101. The cluster energy manager 120 is coupled with the power panel 130 via power panel line 103 and coupled with the communication system 140 via network 104. The communication system 140 is coupled with the monitoring system 150 via network 105.

In one embodiment, the system 1000 includes one or more communication devices (hereinafter, communication device) 160 coupled with the energy manager 120. The communication device 160 may be an energy manager 120, sensor, controller, switch, hub, or other device for automatically or manually assisting in the provision of energy to the workstation cluster 108. The communication device 160 may be independent of or integrated into the system 100.

Although discussed below as independent components, the workstation power line 101 and occupancy line 102 may be the same wire. For example, data over power line technology may be used to transport the workstation energy and/or occupancy data between the workstation 110 and energy manager 120.

Energy is provided from the power panel 130 to the energy manager 120 via power panel line 103. The energy manager 120 receives the workstation energy and distributes the workstation energy based on occupancy, consumption, or other parameters, or combinations thereof. Distributing the workstation energy may include providing workstation energy to the energy outlet 113 via workstation power line 101. The energy outlet 113 may receive the workstation energy. The workstation energy may be used to power the workstation 110. Although any value of workstation energy may be used, one example of a workstation energy value may be a 120 volt 60 Hz alternating current (Vac) power signal.

The system 100 may be used for management of the provisioning of energy to a workstation. The workstation energy may be consumed by energy consumption devices of the workstation 110, which may be referred to as energy consumed by the workstation 110. Management of workstation energy may include detecting occupancy of the workstation 110, measuring an amount of energy consumed by the workstation 110, reporting occupancy and/or workstation energy consumption, distributing, controlling or regulating energy to the workstation 110, or any combination thereof. The system 100 may determine whether the workstation 110 is occupied. The system 100 may distribute workstation energy to the workstation 110 based on occupancy of the workstation 110 or another workstation. Distribution may include providing or cutting off workstation energy provided from the power panel 130. Cutting off workstation energy may include stopping or reducing the flow of all, some, or none of the energy or power to the workstation via power panel line 103. The system 100 may measure the amount of energy consumed by the workstation 110. In one embodiment, the occupancy and/or the amount of consumed energy may be reported to the monitoring system 150 via the communication system 140. However, other cluster related information, such as ambient temperature, ambient lighting conditions, etc. may also be reported to the monitoring system 150. The cluster related information may be detected using the workstation sensor 116. The occupancy, amount of consumed energy, or cluster related information may be continuously or periodically reported to the monitoring system 150.

FIG. 1 provides a simplified view of a system 100 in which the present systems, methods, and devices may be implemented. Not all of the depicted components may be required. Some systems and devices may include additional, different, or fewer components not shown in FIG. 1. The number of additional or fewer components is not limited. A plurality of workstations 110, workstation sensors 116, and/or energy managers 120 may be provided. In one embodiment, a plurality of different workstations are coupled with the energy manager 120 in the same or similar manner that workstation 110 is coupled with the energy manager 120. Variations in the arrangement and type of the components may be made without departing from the spirit or scope of the claims as set forth herein.

The workstation 110 may be an office, cubicle, room, desk, facility, counter, or closet. The workstation 110 may be designed, built, and/or installed to afford a convenience or service. Exemplary conveniences and services include space for working, playing, meeting, computing, organizing, planning, charting, graphing, or another act or combination thereof. The workstation 110 may include one or more workstation components 112, an energy outlet 113, and at least one workstation sensor (hereinafter workstation sensor) 116. The workstation 110 may include additional, different, or fewer components.

The one or more workstation components 112 may include furniture, lighting, or other facility components, such as personal computers, networking endpoints, desks, chairs, couches, closets, refrigerators, whiteboards, blackboards, windows, musical instruments, network devices, picture frames, pencils, pens, markers, clothing, uniforms, mailboxes, lights, or other facilities. The one or more workstation components 112 may include energy consuming devices or non-energy consuming devices. An energy consumption device requires energy to operate (e.g., lighting system), be operated (e.g., personal computer), or be operated or charged over time (e.g., laptop with battery). An energy consumption device may be referred to as an electrical load, energy or power load component, power consumption device, or other device needing power to operate or be operated. A non-energy load component does not require energy to operate or be operated. A device having a battery that requires re-charging may be considered an energy consuming device because it requires energy to be operated over time.

The energy outlet 113 may be a power whip, central energy outlet, power outlet, or other distribution outlet for supplying energy or power to the workstation. The energy outlet 113 may be a coupling to an energy consuming device and may be a hardwired connection to the device or a wired or wireless receptacle capable of receiving a connection to the device. In one example, the energy outlet 113 is a 120 Vac outlet plug-in device. The energy consuming devices of the workstation 110 may be coupled with (e.g., plugged into or hardwired to) the energy outlet 113 and receive energy via the energy outlet 113. The energy outlet 113 may supply all, some, or none of the energy to the energy consuming devices of the workstation 110. For example, all, some, or none of the energy consuming devices may not operate or must operate on an alternative power sources, such as a batteries, when workstation energy is not being supplied to the energy outlet 113.

The example of FIG. 1 shows workstation 110 having a personal computer 112a, chair 112b, and a lighting system 112c. The workstation 110 may include additional, different, or fewer workstation components 112. Personal computer 112a, chair 112b, and a lighting system 112c are workstation components 112. The personal computer 112a and lighting system 112c are energy consuming devices. The chair 112b is a non-energy consuming device. The personal computer 112a and lighting system 112c are plugged into the energy outlet 113, for example, using power cords. When supplied with workstation energy from the energy manager 120, the energy outlet 113 provides workstation energy to the personal computer 112a and lighting system 112c.

The energy manager 120 is coupled with the energy outlet 113 via workstation power line 101. The workstation power line 101 may be a power cable, cord, circuit, backbone, hub, or other device for routing energy to the workstation component 112. The workstation power line 101 provides energy to the energy outlet 113. The personal computer 112a and the lighting system 112c are coupled with the energy outlet 113. As a result, the personal computer 112a and lighting system 112c receive workstation energy from the workstation power line 101. The chair 112b may not consume energy and may not be coupled with the energy outlet 113. Additional workstation power lines 101 may be used. The workstation power line 101 may be sized to provide sufficient workstation energy to the workstation component 112. In one example, a power cable with the appropriate gauge is selected as the workstation power line 101.

The workstation 110 may be occupied by a user 114. The user 114 occupies the workstation 110 when using, operating, maintaining, taking or filling up space in, engaging, residing in, dwelling in, taking possession of, or controlling the workstation 110 and/or one or more of the workstation components 112. Accordingly, as used herein, the term “occupied” may include being used, being operated, being maintained, taken or filled up, engaged, being resided in, having been taken possession of, or controlled. For example, the user 114 occupies the workstation 110 when the user 114 operates the personal computer 112a, sits in the chair 112b, uses the lighting system 112c, or a combination thereof. In another example, the user 114 occupies the workstation 110 when the user 114 passes through an entry way (e.g., door) into the workstation 110.

The workstation 110 may include a workstation sensor 116. The workstation sensor 116 may be an occupancy sensor that is operable to detect when the workstation 110 is occupied by the user 114. The workstation sensor 116 may be a motion sensor, passive infrared sensor, RFID reader, ultrasound sensor, CCD sensor, accelerometer, piezo sensor, proximity sensor, capacitive proximity sensor, touch sensor, microwave sensor, pressure sensor, operation sensor, strain gauge sensor, heat sensor, temperature sensor, humidity sensor, carbon dioxide sensor, noise sensor, any combination thereof, or other sensor or system of sensors for detecting occupancy. The workstation sensor 116 may be a wall-mounted sensor, ceiling-mounted sensor, desk-mounted sensor, chair-mounted sensor, computer-mounted sensor, door-mounted sensor, or other sensor mounted in, on, below, above, or around the workstation 110.

The workstation sensor 116 may be coupled with the cluster energy manager 120 via an occupancy line 102. The occupancy line 102 may be a cable, wireless transmission line, telecommunication cable, telephone cable, or other communication line for transmitting occupancy signals. In one example, the occupancy line 102 is a telephone cable with an RJ11 or RJ45 connectors on both ends. One of the RJ11/RJ45 connectors may be plugged into the workstation sensor 116 and the other RJ11/RJ45 connector may be plugged into the cluster energy manager 120. The workstation sensor 116 may transmit an occupancy signal to the cluster energy manager 120 via the occupancy line 102. The occupancy signal may define whether the workstation is occupied or not occupied by the user 14. The occupancy signal may be raw data or processed data. In other words, the workstation sensor 116 may include processing capabilities. In one example, the workstation sensor 116 is a Watt Stopper DI-110 sensor, sold by Watt Stopper having a place of business in Santa Clara, Calif.

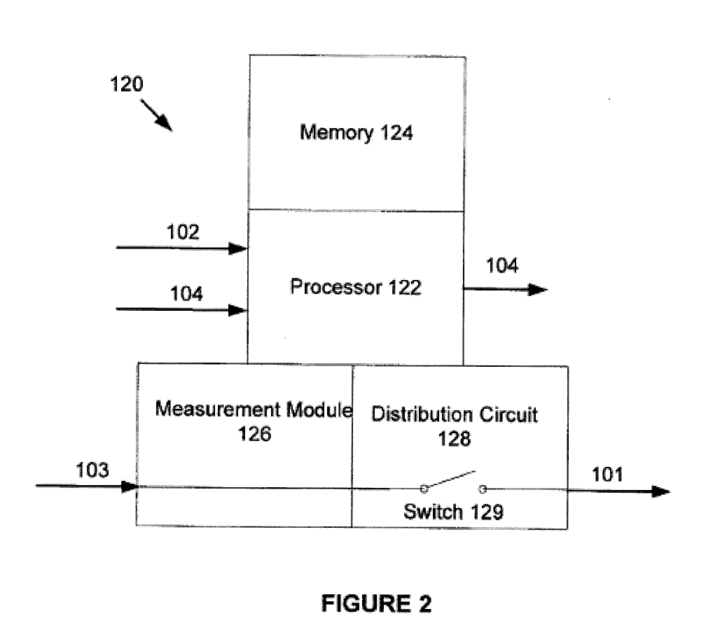

FIG. 2 illustrates one embodiment of a cluster energy manager 120. FIG. 2 is a block diagram of the workstation energy manager 120. The cluster energy manager 120 may manage workstation energy for one or more workstations 110. The cluster energy manager 120 is operable to manage the distribution, reporting, and/or measurement of workstation energy. The energy manager 120 may include a processor 122, memory 124, measurement module 126 and a distribution circuit 128. The distribution circuit 128 may include a switch 129 that is operable to connect and disconnect the workstation power line 101 and the power panel line 103.

In alternative embodiments, the cluster energy manager 120 includes additional, different, or fewer components. For example, in one embodiment, the cluster energy manager 120 may include a display for displaying output. Output may include an image or audio signal that relates to management of workstation energy. The display may be a liquid crystal display, touch panel display, or other monitor for displaying images. In another example, as discussed in more detail below, an alternating current/direct current (AC/DC) converter may be provided. The AC/DC converter may convert a 120Vac power signal into a 12 volt direct current (Vdc) power signal. The processor 122, memory 124, measurement module 126 and distribution circuit 128 may use the 12Vdc power signal during operation. In yet another example, the cluster energy manager 120 may include an input, such as a keyboard, mouse, or touch display for providing management parameters to the cluster energy manager 120.

The processor 122 may be a general processor, digital signal processor, application specific integrated circuit, field programmable gate array, analog circuit, digital circuit, combinations thereof, or other now known or later developed processors. The processor 122 may be a single device or a combination of devices, such as associated with a network or distributed processing. Any of various processing strategies may be used, such as multi-processing, multi-tasking, parallel processing, or the like. Processing may be local, as opposed to remote. The processor 122 may be programmed to execute instructions stored in memory 124. The processor 122 may be responsive to instructions stored as part of software, hardware, integrated circuits, firmware, micro-code or the like.

The processor 122 is operable to communicate with the workstation occupancy sensor 116, memory 124, measurement module 126, distribution circuit 128, and communication system 140. As used herein, the term “operable to communicate” includes operable to transmit, receive, or both transmit and receive. As a result, the processor 122 is operable to transmit and/or receive signals, such as occupancy signals, consumption signals, network signals, workstation information signals, cluster-related signals, or control signals.

An occupancy signal may be transmitted via the occupancy line 102, the network 104, the network 105 (shown in FIG. 1), or a combination thereof. The occupancy signal may define occupancy of the workstation 110 and/or the workstation cluster 108. A consumption signal may be transmitted via the occupancy line 102, the network 104, the network 105, or a combination thereof. The consumption signal may define an amount of workstation energy consumed by a workstation 110 and/or workstation cluster 108. A network signal may be transmitted via the network 104, the network 105, or a combination thereof. The network signal may define a network event. A network event may be an event or instruction received across a network, such as network 104 or network 105. The network event may be a timed event, calendar event, reservation event, scheduling event, administrator instruction, remote controlled instruction, or other event or instruction received for controlling the provisioning of energy. Alternatively, or additionally, the network signal may be a manually-triggered signal that is defined by manual input. A control signal may be transmitted from the processor 122 to the distribution circuit 128. The control signal may control the switch 129. The control signal may open or close the switch 129 (discussed below).

The processor 122 is operable to determine occupancy. Determining occupancy may include receiving an occupancy signal from the workstation occupancy sensor 116. The occupancy signal may be raw data or a processed signal. In other words, the workstation occupancy sensor 116 may detect information about workstation 110 occupancy. The information may be processed or transmitted without processing. The processor 122 may use the received occupancy signal to determine whether the workstation is occupied or vacant. As used herein, the term “vacant” may include not occupied by the user 14. In one example, the occupancy signal includes a text message, audio message, or graphical message that the workstation 110 is “occupied” or “vacant.” Other indications may be used. For example, a binary “1” may indicate that the workstation is occupied and a binary “0” may indicate that the workstation 110 is vacant. Strings of binary numbers may be used.

The processor 122 is operable to determine an amount of workstation energy consumed by some or all of the distribution circuit 128. Determining an amount of workstation energy consumed may include measuring workstation energy that is transferred, passed, or distributed from the power panel line 103 to the workstation power line 101. In one embodiment, determining an amount of workstation energy consumed may include receiving a consumption signal from the measurement module 126. The measurement module 126 may measure the amount of workstation energy consumed and transmit a consumption signal to the processor 122. The consumption signal may be raw data or a processed signal. The processor 122 may use the received consumption signal to determine the amount of workstation energy consumed.

The processor 122 is operable to distribute workstation energy based on occupancy, consumption, and/or a network event. Distributing may include controlling a distribution circuit 128. Controlling the distribution circuit 128 may include controlling one, some, or all of one or more switch circuits 129 in the distribution circuit 128. Controlling the one or more switch circuits 129 may include opening, closing, connecting, or disconnecting one, some, or all of the one or more switch circuits 129. As used herein, when switch circuit 129 is “opened,” the workstation power line 101 may not be coupled with the power panel line 103. In other words, workstation energy, which is provided from the power panel 130, is not provided to the energy outlet 113. However, when the switch circuit 129 is “closed,” the power panel line 103 may be coupled with the workstation power line 101. In other words, workstation energy is provided to the energy outlet 113. The one or more switch circuits 129 may be opened or closed based on occupancy, amount of workstation energy consumed, or network signals.

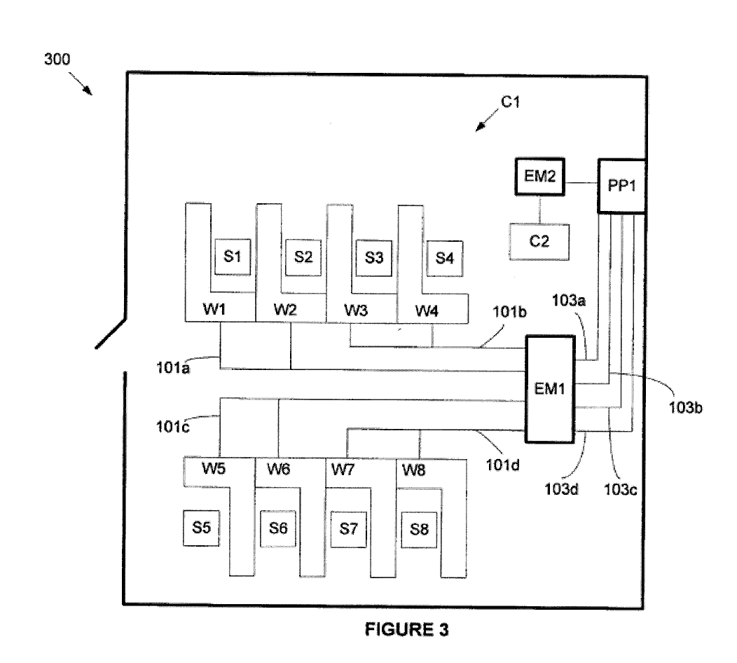

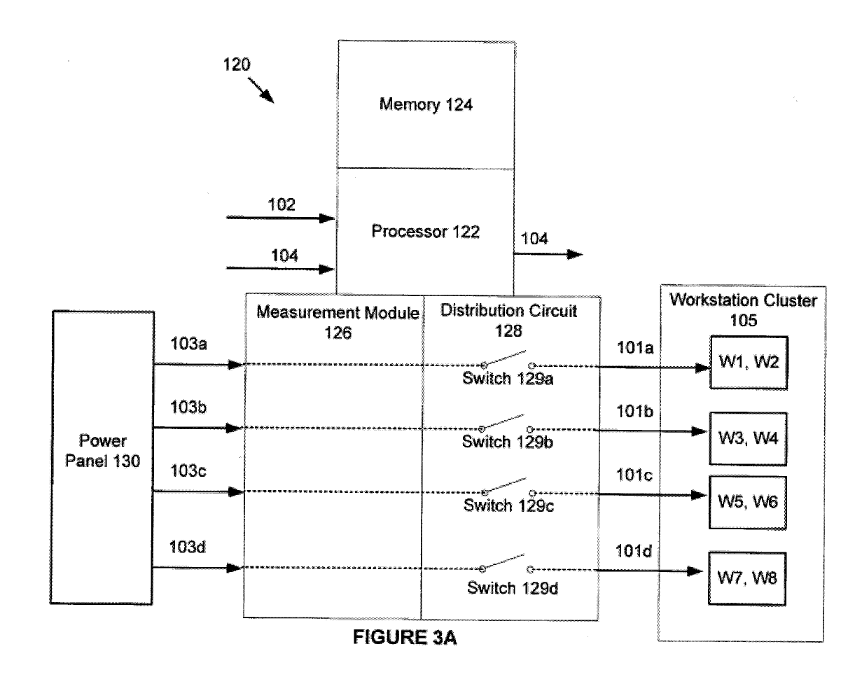

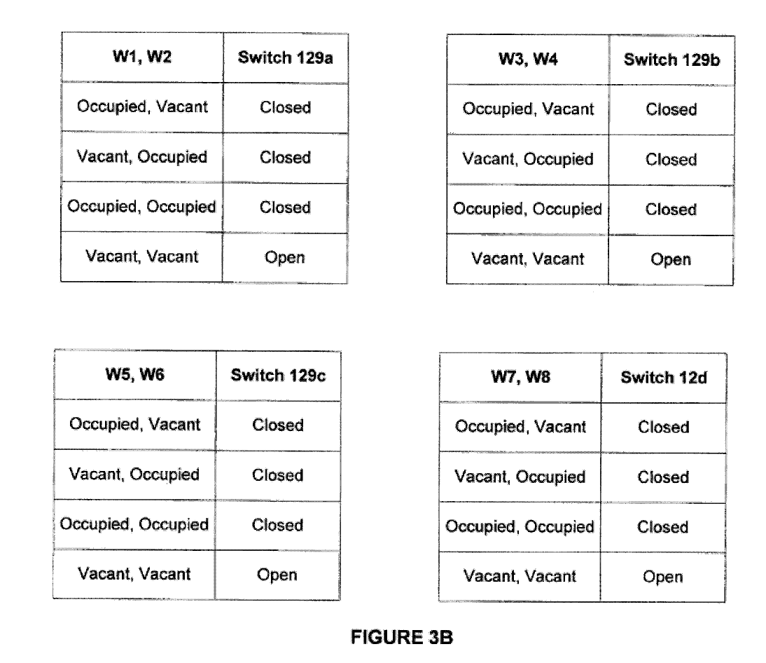

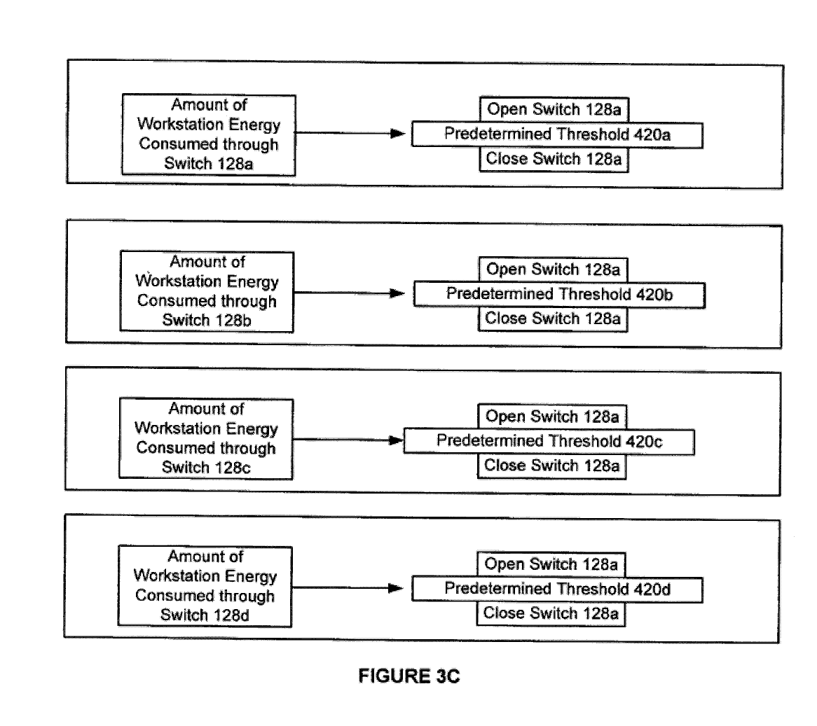

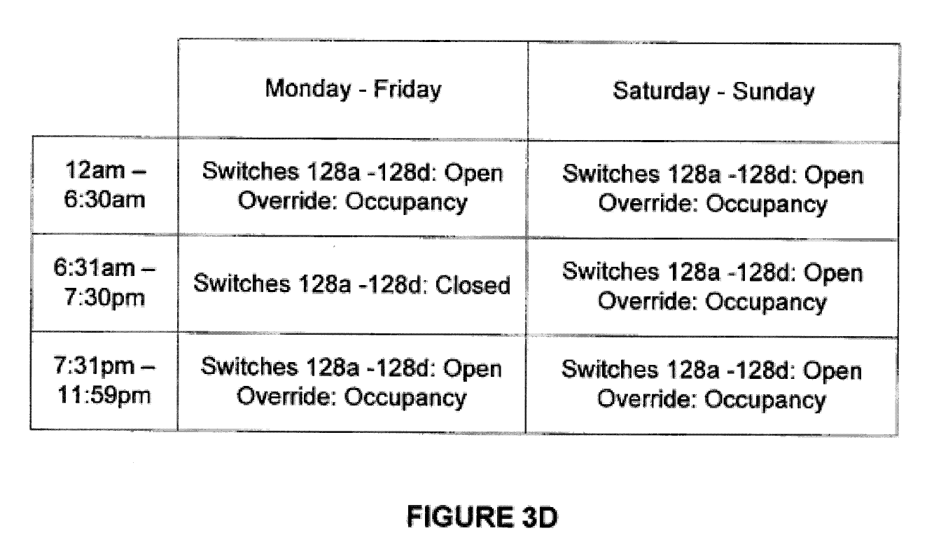

FIGS. 3, 3A, 3B, 3C, and 3D illustrate exemplary embodiments of the processor 122 controlling the distribution circuit 128. FIG. 3 illustrates an office environment 300 having a plurality of workstation clusters 105, a plurality of workstations 110, workstation sensors 116, and energy managers 120. As shown and described in the example of FIG. 3, the plurality of workstation clusters 105 are clusters C1-C2, the plurality of workstations 110 are cubicles W1-W12, the workstation sensors 116 are occupancy sensors S1-S12, and the energy managers 120 are cluster energy managers EM1-EM2. A power panel 130 is shown as a power panel PP1 and a communication system 140 is shown as a communication system CS1. Although FIG. 3 illustrates cubicles W1-W4 separated by a distance from cubicles W5-W8, the cubicles W1-W8 may be connected or positioned together.

FIG. 3A illustrates one embodiment of a cluster energy manager 120 that is configured to manage the workstation cluster C1 in the office environment 300. The power panel 120 is coupled with the energy manager 120 via four (4) different power panel lines 103a-103d. The cluster energy manager EM1 includes a distribution circuit 128 that includes switches 129a-129d. In this embodiment, each switch controls workstation energy to the energy outlets of two, different workstations. The energy outlet 113 of workstation W1 and the energy outlet 113 of workstation W2, which may be different and distinct energy outlets 113, may be coupled with the workstation energy line 101a. The energy outlet 113 of workstation W3 and the energy outlet 113 of workstation W4, which may be different and distinct energy outlets 113, may be coupled with the workstation energy line 101b. The energy outlet 113 of workstation W5 and the energy outlet 113 of workstation W6, which may be different and distinct energy outlets 113, may be coupled with the workstation energy line 101c. The energy outlet 113 of workstation W7 and the energy outlet 113 of workstation W8, which may be different and distinct energy outlets 113, may be coupled with the workstation energy line 101d. Other allocations, assignments, or configurations may be used. For example, one switch per one energy outlet 113, one switch per three energy outlets 113, or other combination.

FIG. 3B illustrates one embodiment of controlling the distribution circuit 128 based on occupancy. FIG. 3B is a table showing controlled states of the switches 129a-129d. The controlled states are based on occupancy of the workstations. As shown in FIG. 3B, when one of the associated workstations is occupied, the corresponding switch may be closed to allow workstation energy to pass to associated workstations. The switch 129 may be closed by OR-ing the states of occupancy for workstations associated with the switch 129. The switch 129 may be opened by AND-ing the states of occupancy for workstations associated with the switch 129. Workstations are associated together or with a switch 129 based on being coupled to the same workstation energy line 101. For example, workstation W1 is associated with workstation W2 and workstations W1, W2 are associated with switch 129a. In the example of FIG. 3B whenever workstation W1 is occupied, switch 129a is closed. However, when W1 and W2 are unoccupied, the corresponding switch 129a may be opened to cut off workstation energy to workstations W1 and W2. For example, whenever workstation W1 and W2 are vacant, switch 129a is opened.

FIG. 3C illustrates one embodiment of controlling the distribution circuit 128 based on energy consumption. FIG. 3C is a table showing controlled states of the switches 129a-129d. The predetermined threshold 420a may be determined before, during, or after operation of the cluster energy manager 120. For example, the predetermined threshold 420a may be automatically determined by monitoring system 150 or manually determined by an administrator and communicated to the processor 122 using the communication system 140. The processor 122 may determine the amount of workstation energy consumed, for example, hourly, daily, weekly, monthly, or yearly, through switch 128a. The processor 122 may compare the amount of workstation energy to the predetermined threshold 420a. When the amount of workstation energy is greater than or equal to the predetermined threshold 420a, then the switch 128a may be opened. However, when the amount of workstation energy is less than the predetermined threshold 420a, then the switch 128a may be closed. Other rules may be used. For example, the switch 128a may be closed when the amount of consumed workstation energy is greater than or equal to the predetermined threshold 420a and the switch 128a may be opened when the amount of consumed workstation energy is less than the predetermined threshold 420a.

FIG. 3D illustrates one embodiment of controlling the distribution circuit 128 based on a network event stored in memory 124 or provided from the communication system 140. In the example shown in FIG. 3D, the network event is a calendar event. A network administrator may control a calendar from a remote location, for example, using the communication system 140 to transmit the network event to the energy manager 140 in a network signal. The calendar may be used to control the distribution circuit 128. For example, during peak times, such as 6:31 am-7:30 pm on Monday-Friday, the switch 128a may be closed. During non-peak times, such as 12 am-6:30 am and 7:31-11:59 pm on Monday-Friday and all day on Saturday and Sunday, the switch 129a may be opened. As used herein, peak times relate to work hours, for example, when most employees are at the office. Non-peak times relate to non-wok hours, for example, when most employees are not at the office. In order to allow employees to work during non-peak times, the switch 129a may be overridden by an occupancy override parameter. The occupancy override parameter may operate according to the principles of FIG. 3B and the discussion of FIG. 3B.

Referring back to FIG. 2, the processor 122 is operable to communicate via network 104. The network 104 may be a wireless or wired network. In one example, the processor 122 communicates via a wireless network, such as a wireless personal area network, wireless local area network or other wireless network. The wireless network may be standardized under the IEEE 802.11 series. In another example, the cluster energy manager 120 includes a port coupled with the processor 122. The port may receive a cable, such as a CAT-5 cable, that is coupled with the communication system 140.

The processor 122 is operable to transmit signals to the communication system 140 or other electronic devices. For example, the processor 122 may transmit a control signal to an external control device that may be used to control the lighting, heating, ventilation, air conditioning, or other controllable feature. The control signal may be used to turn off, turn on, or adjust the external control device. In one example, the processor 122 may determine the occupancy of the one or more workstations 108 and transmit a control signal to a lighting control panel controlling the lights around the one or more workstations 108. The control signal may be used to shut off the lights when the one or more workstations 108 are not being occupied.

The memory 124 may be computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 124 may be a single device or a combination of devices. The memory 124 may be adjacent to, part of, networked with and/or remote from the processor 122.

The memory 124 may store data representing instructions executable by the programmed processor 122. The processor 122 is programmed with and executes the instructions. The functions, processes, acts, methods or tasks illustrated in the figures or described herein are performed by the programmed processor 122 executing the instructions stored in the memory 124. The functions, acts, processes, methods or tasks are independent of the particular type of instructions set, storage media, processor or processing strategy and may be performed by software, hardware, integrated circuits, firm ware, micro-code and the like, operating alone or in combination.

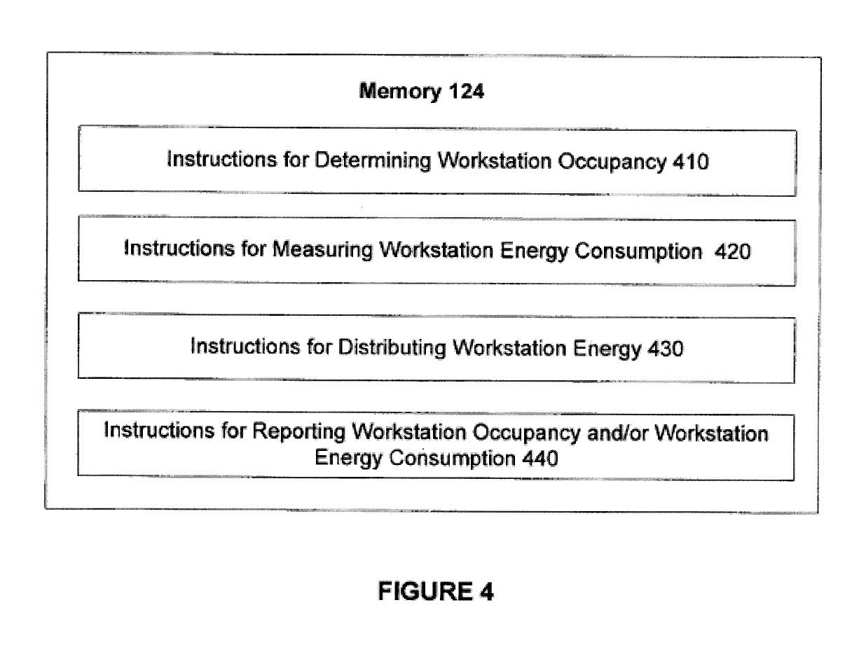

FIG. 4 illustrates one embodiment of the memory 124 storing instructions. The instructions may include instructions for determining occupancy 410, instructions for measuring workstation energy consumption 420, instructions for distributing workstation energy 430, and instructions for reporting workstation occupancy and/or workstation energy consumption 440. The instructions for determining occupancy 410 may be executed to determine occupancy of one or more workstations. The instructions for measuring workstation energy consumption 420 may be executed to determine workstation energy consumed by one or more workstations. The instructions for distributing workstation energy 430 may be executed to distribute energy to one or more workstations. Distribution may be based on occupancy and/or workstation energy consumption. The instructions for reporting workstation occupancy and/or workstation energy consumption 440 may be executed to report occupancy and/or workstation energy consumption to a monitoring system.

Referring back to FIG. 2, the measurement module 126 may include one or more measurement circuits. The measurement module 126 may include one or more master measurement circuits and/or one or more slave measurement circuits. The measurement module 126 may be coupled with the power panel 130 and the distribution circuit 128. The measurement module 126 may receive workstation energy provided from the power panel 130. The measurement module 126 is operable to measure the amount of energy consumed by the distribution circuit 128. In one example, a different measurement circuit may correspond to the one or more switches 128. The different measurement circuits may measure the amount of workstation energy provided via each of the switches 128.

The distribution circuit 128 may be relays, transistors, switches, or other devices for cutting off and providing power to one or more workstations 110. As discussed above, the distribution circuit 128 may be controlled by the processor 122. The distribution circuit 128 may receive workstation energy from the measurement module 126 or power panel 130. The distribution circuit 128 may distribute workstation energy.

Variations in the arrangement and type of the components used to form the cluster energy manager 120 may be made without departing from the spirit or scope of the claims as set forth herein. For example, in one embodiment, the energy manager 120 may include management modules for managing workstation energy. The management modules may include hardware, software, or hardware and software. For example, processors, memory, circuits, instructions, or a combination thereof may be used. Processors, memory, circuits, instructions, or a combination thereof may be shared between modules. The energy manager 120 may include an occupancy module, measurement module, distribution module, and reporting module. The occupancy module may determine occupancy of one or more workstations. The measurement module may determine workstation energy consumed by one or more workstations. The distribution module may distribute energy to one or more workstations. Distribution may be based on occupancy and/or workstation energy consumption. The reporting module may report occupancy and/or workstation energy consumption to a monitoring system. Additional, different, or fewer management modules may be provided. For example, the measurement module may be removed. The arrangement and type of management modules may be determined based on customer preference, cost, usage, or other manufacturing or application consideration.

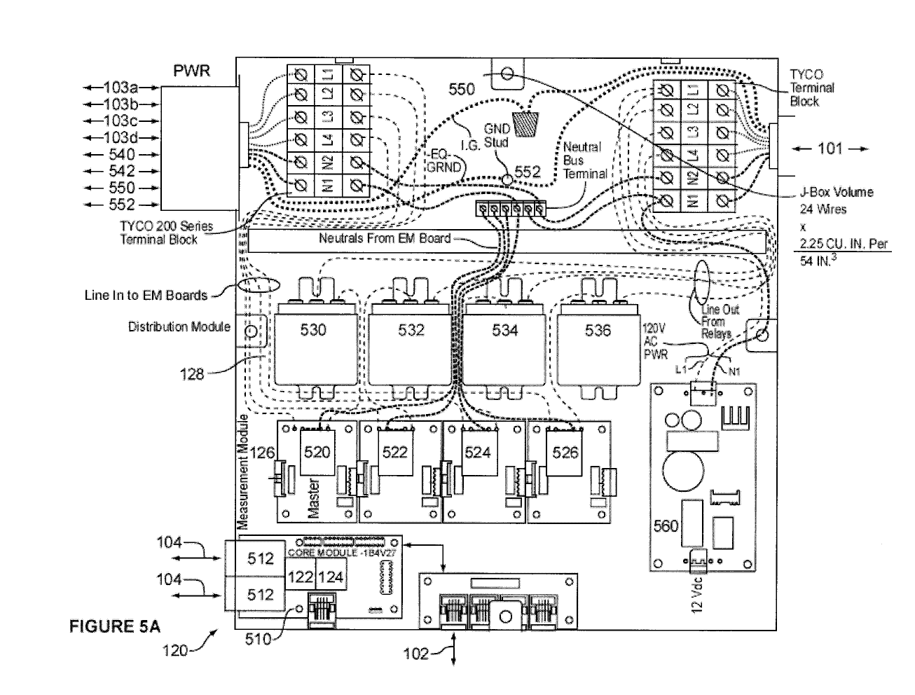

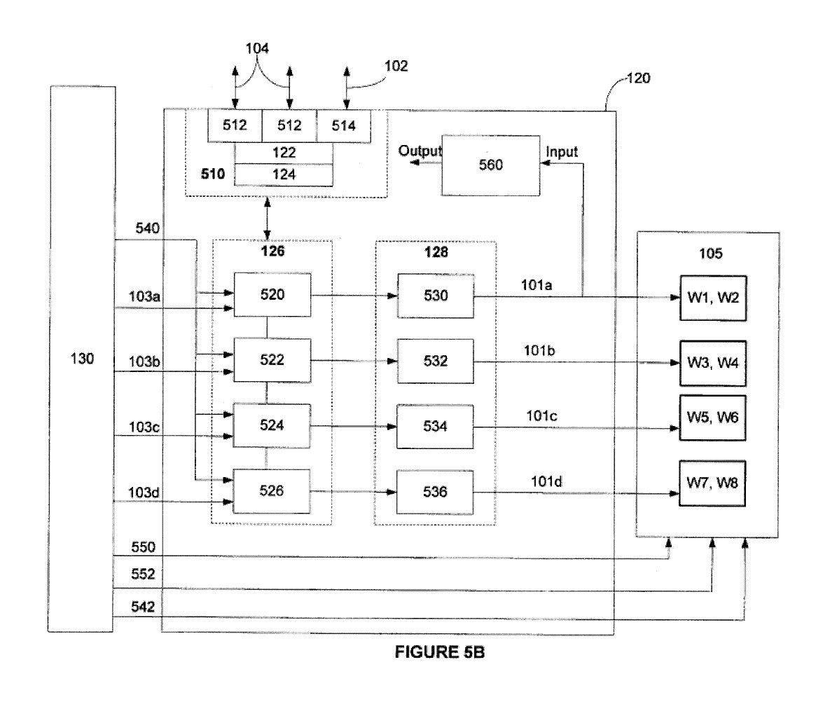

In another embodiment, the cluster energy manager 120 may be designed, built, and/or manufactured as shown in the schematic of FIG. 5. The cluster energy manager 120 may include a core module that includes the processor 122, memory 124, one or more ports 512 for communicating via the network 104, and one or more ports 514 for communicating via the occupancy line 102. The core module 510 may include additional, different or fewer components. The core module 510 may be coupled with the measurement module 126 and distribution circuit 128 using circuits, wires, transmitters, receivers, or other communication lines or channels. The core module 510 may be operable to control the distribution circuit 128. The measurement module 126 may include a master control unit 520 and slave control units 522, 524, 526. The control units 520, 522, 524, 526 may measure the amount of energy provided to the distribution circuit 128 from the power panel lines 103. The amount of energy may be provided to the core module 510, for example, through the master control unit 520. The distribution circuit 128 may include relays 530, 532, 534, 536. The relays 530, 532, 534, 536 may be used for control the amount of energy provided from the power panel line 103 to the workstation power line 101. The energy manager 120 may include an AC/DC converter 560 for converting high voltage (V) alternating current (AC) energy (e.g. 120VAC) to low voltage direct current (DC) energy (12VDC).

FIGS. 5A and 5B show an energy manager 120 with a 4-2-2 configuration. FIG. 5A shows a schematic diagram of one embodiment of the energy manager 120 and FIG. 5B shows a block diagram of the embodiment shown in FIG. 5A. The configuration relates to the number of active (i.e., hot) lines, neutral lines, and ground lines provided from the power panel 130. For example, there are four (4) active power panel lines 103a-103d, two (2) neutral lines 540, 542, and two (2) ground lines 550, 552. The neutral lines 540, 542 may be provided to the measurement module 126 for measuring an amount of workstation energy. The ground line 550 may be an isolated ground and the ground line 552 is an equipment ground. The isolated ground may be coupled with the workstation power line 101, without being grounded to another component. The equipment ground may be grounded to a metal box or other equipment. Other configurations may be used. For example, a 3-1-1 configuration may be used. The 3-1-1 configuration may include three (3) power panel lines, one (1) neutral line, and one (1) ground line.

In other embodiments, for example, instead of managing two workstations per line, it may be beneficial to manage four workstations per two lines. A first line may be dedicated to devices that constantly need power (e.g., computers, refrigerators, fire alarms, etc.) and a second line may be dedicated to devices that may be shut down without causing concern (e.g., lights, cell phone chargers, etc.). The energy manager 120 may manage energy provided to the second line based on, for example, occupancy. The energy to the second line may be shut down or cut off. The energy to the first line may be left constant, so the energy consuming devices connected to the first line always have energy.

In one embodiment, the power is not actually turned off but, instead, the system may transition into a low-power or trickle charge mode. This would be useful to maintain power to devices which need to remain in a stand-by mode, etc. The energy may be cut off or reduced immediately, after the elapse of a defined or variable amount of time, or gradually reduced from a first amount to a second amount, such as zero, over a period of time.

In one embodiment, the system 100 may include a controllable receptacle disposed at the workstation 110. The cluster energy manager 120 may control the controllable receptacle. The controllable receptacle may include one or more relays for provisioning energy to one or more energy outlets 113 in the workstation 110. In order to control the controllable receptacle, the cluster energy manager 120 may transmit a control signal via a control line. The control signal may be used to control the one or more relays. Accordingly, the cluster energy manager 120 may provide remote control for the controllable receptacle. In one example, the controllable receptacle may be coupled with the workstation sensor 116 and the occupancy line 102. The controllable receptacle may also switch on/off autonomously, i.e. without a control signal from the cluster energy manager. The controllable receptacle may be configured to relay occupancy of the cluster energy manager 120.

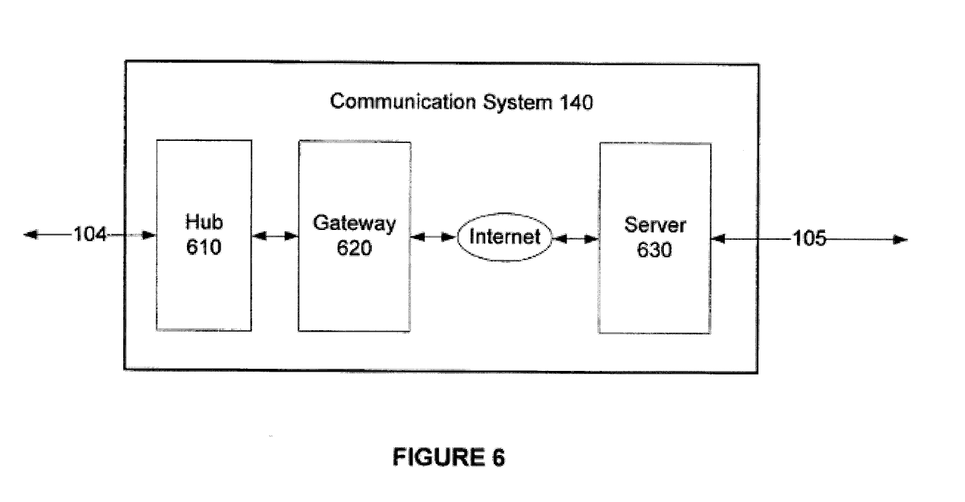

FIG. 6 illustrates one embodiment of a communication system 140. The communication system 140 may include a hub 610, gateway 620, and server 630. Additional, different, or fewer components may be provided. For example, the communication system 140 may include routers, personal computers, cellular devices, satellite devices, or other communication devices for routing signals from the energy manager 120 to the monitoring system 150 or vice-versa. The communication system 140 is used for communicating. For example, in the example of FIG. 6, signals are provided from the energy manager 120 to the hub 610, which provides the signals to the gateway 620 for transfer via the Internet. The gateway 620 prepares and transfers the signals via the Internet to the server 630. The server 630 may store the signals in a database for later retrieval. The server 630 receives the signals and provides the signals to the monitoring system 150.

The monitoring system 150 may be a personal workstation, personal computer, network administrator, server, or other device for analyzing and managing the energy manager 120. For example, occupancy of the workstation cluster 108 may be provided to the monitoring system 150. In another example, consumption of the workstation cluster 108 may be provided to the monitoring system 150. The monitoring system 150 may view or store the occupancy or consumption. The monitoring system 150 may be used to send instructions, for example, to the energy manager 120. The instructions may be provided in a network signal. The instructions may be considered a network event.

In one embodiment, the monitoring system 150 is a Computer Aided Facility Management (CAFM) system. The CAFM system may be used to support facilities management. For example, a CAFM system may be used to track and maintain floor plans, building and property information, space characteristics and usage, employee and occupancy data, workplace assets (furniture and equipment), business continuity and safety information, local area network and telecom information. The CAFM system may use the energy manager 120 to further support facilities management. For example, the CAFM system may use the energy manager 120 to control usage of energy to ensure that an energy threshold is not exceeded.

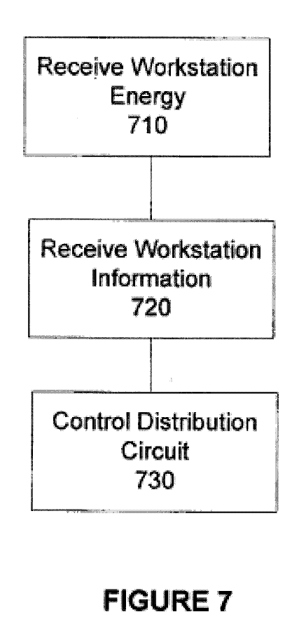

FIG. 7 illustrates a method of managing workstation energy. The method is implemented with the system of FIG. 1, FIG. 2, or a different system. A device may be configured, manufactured, or programmed to perform the acts in the method. The device may be sold or otherwise distributed for application by others. As another example, the use of the device is charged. The acts are performed in the order shown or a different order. Additional, different, or fewer acts may be provided.

The method 700 includes receiving workstation energy via a workstation power line 710, receiving a network signal defining at least one network event 720; and managing the distribution of workstation energy to the one or more workstations based on the at least one network event 730.

In act 710, an energy manager receives workstation energy via a workstation power line. The workstation energy operable to provide energy to a workstation cluster having one or more workstations. The workstation energy may be received from a power panel. In act 720, the energy manager receives a network signal defining at least one network event. Receiving the network signal may include receiving occupancy signals, measurement signals, network signals, or switch signals. Occupancy signals may define occupancy of the one or more workstations. Receiving may include receiving from a workstation sensor, accessing a memory, or receiving from a communication system. In act 730, workstation energy may be distributed to the one or more workstations via a workstation power line. Managing the distribution of workstation energy may include controlling one or more switches that connects and disconnects the workstation power line and the power panel line. Controlling may include opening and closing. Determining workstation occupancy of the workstation cluster may include using a workstation sensor, workstation occupancy defining when a workstation is occupied.

The method 700 may also include measuring workstation energy distributed to the one or more workstations. Furthermore, the method may include reporting occupancy and measured workstation energy to a monitoring system via a network.

Various improvements described herein may be used together or separately. Any form of data mining or searching may be used. Although illustrative embodiments have been described herein with reference to the accompanying drawings, it is to be understood that the invention is not limited to those precise embodiments, and that various other changes and modifications may be affected therein by one skilled in the art without departing from the scope or spirit of the invention.

We claim:

1. A system for management of workstation energy, the system comprising:
a workstation having an energy outlet operable to receive energy from a source and provide the energy to one or more energy consuming devices of the workstation;
a workstation occupancy sensor associated with the workstation, the workstation occupancy sensor being operable to detect occupancy of the workstation; and
a cluster energy manager coupled with the energy outlet and workstation occupancy sensor, the cluster energy manager having a distribution circuit configured to control energy provided to the energy outlet, the cluster energy manager operable to control the energy based on occupancy of the workstation.

2. The system of claim 1, wherein occupancy of the workstation includes occupation by a user of the workstation.

3. The system of claim 1, wherein the distribution circuit includes a relay coupled with a workstation power line and a power panel line, the workstation power line being operable to provide workstation energy from the cluster energy manager to the energy outlet and the power panel line being operable to provide workstation energy from a power panel to the cluster energy manager.

4. The system of claim 1, wherein the cluster energy manager further comprises a measurement module that is operable to measure an amount of workstation energy provided from the power panel line to the workstation power line, the amount of workstation energy being defined in a consumption signal.

5. The system of claim 4, wherein the cluster energy manager is operable to transmit the consumption signal to a monitoring system via a network.

6. The system of claim 1, wherein the cluster energy manager is operable to receive a network event from a communication system via a network and control the energy based on the network event, the network event being a timed event, calendar event, reservation event, scheduling event, administrator instruction, or remote controlled instruction.

7. The system of claim 1, wherein the cluster energy manager is operable to report occupancy of the workstation to a monitoring system via a network, the occupancy being defined in an occupancy signal.

8. The system of claim 1, wherein the workstation is connected in a workstation cluster.

9. The system of claim 1, wherein the distribution circuit is configured to manage provisioning of energy to the workstation and a different workstation having a different energy outlet.

10. The system of claim 9, wherein the cluster energy manager is operable to control the workstation energy to the workstation and the different workstation based on occupancy of the workstation and the different workstation, a network event defined in a network signal received via a network from a communication system, or a combination thereof.

11. A method for management of workstation energy, the method comprising:
receiving workstation energy via a power panel line, the power panel line being operable to provide workstation energy to a workstation cluster having one or more workstations;
receiving a network signal defining a network event, the network signal being received via a network; and
managing the distribution of workstation energy to the one or more workstations based on the network event, workstation energy being distributed to the one or more workstations via a workstation power line.

12. The method of claim 11, further comprising receiving an occupancy signal from an occupancy sensor, the occupancy signal defining occupancy of the one or more workstations.

13. The method of claim 12, further comprising managing the distribution of workstation energy to the one or more workstations based on the received occupancy signal.

14. The method of claim 12, further comprising determining workstation occupancy of the workstation cluster using a workstation sensor, workstation occupancy defining when a workstation is occupied.

15. The method of claim 12, further comprising reporting occupancy and measured workstation energy to a monitoring system via a network.

16. The method of claim 11, wherein the network event is a timed event, calendar event, reservation event, scheduling event, administrator instruction, or remote controlled instruction.

17. The method of claim 11, wherein managing the distribution of workstation energy includes controlling one or more relays that connect or disconnect the workstation power line and the power panel line.

18. The method of claim 17, wherein controlling includes opening and closing the one or more relays.

19. The method of claim 17, wherein a processor is operable to open and close the one or more relays based on the network event.

20. The method of claim 11, further comprising measuring workstation energy distributed to the one or more workstations.

21. An energy manager comprising:
a processor;
a memory coupled with the processor, the processor being operable to execute instructions stored on the memory, the memory storing:
instructions for determining an occupancy of one or more workstations;
instructions for receiving a network signal via a network, the network signal defining a network event; and
instructions for distributing workstation energy to one or more workstations based on the occupancy of the one or more workstations, the network event, or the combination thereof.

22. The energy management device of claim 21, wherein the memory further stores instructions for measuring workstation energy consumption.

23. The energy management device of claim 21, wherein the instructions for distributing workstation energy include instructions for controlling one or more relay circuits, the control of the one or more relay circuits including switching off and on workstation energy.

24. The energy management device of claim 21, wherein the memory further stores instructions for reporting occupancy and workstation energy consumption to a monitoring system via a network, reporting including transmitting occupancy and workstation energy consumption to a communication system.

25. The energy management device of claim 21, wherein the network may include a local area network or Internet.

26. A method for management of workstation energy, the method comprising:
receiving workstation energy via a workstation power line, the workstation energy operable to provide energy to a workstation cluster having one or more workstations;
receiving an occupancy signal from an occupancy sensor, the occupancy signal defining occupancy of the one or more workstations; and
managing the distribution of workstation energy to the one or more workstations based on the occupancy, workstation energy being distributed to the one or more workstations via a workstation power line.

27. A system for management of workstation energy, the system comprising:
a workstation having an energy outlet operable to receive energy from a source and provide the energy to one or more energy consuming devices of the workstation; and
a cluster energy manager coupled with the energy outlet and a network, the cluster energy manager having a distribution circuit configured to control energy provided to the energy outlet, the cluster energy manager operable to receive a network event via the network and control the energy based on the network event.
